(19) United States
(12) Patent Application Publication
(10) Pub. No.: US 2007/0247409 A1
(43) Pub. Date: Oct. 25, 2007

(54) Liquid crystal display apparatus containing driver IC with grayscale voltage generating circuit

(75) Inventors: Kouichi Nishimura, Kanagawa (JP); Takanori Sumiya, Kanagawa (JP); Hideki Akahori, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/785,756

(22) Filed: Apr. 19, 2007

(30) Foreign Application Priority Data
Apr. 20, 2006 (JP) 2006-116275

(51) Int. Cl. G09G 3/36

(52) U.S. Cl. 345/89

(57) ABSTRACT

A liquid crystal display (LCD) driver integrated circuit includes a grayscale voltage generating circuit configured to generate a plurality of grayscale voltages from a set of supply reference voltages; and a converting section having connection terminals and configured to drive each of a plurality of data lines of a liquid crystal display panel through one of the connection terminals based on one of the plurality of grayscale voltages which is determined based on an input data, when each of a plurality of scanning lines of the liquid crystal display panel is driven. The grayscale voltage generating circuit includes a resistance circuit having resistances connected in series; and a plurality of voltage buffers connected to the resistance circuit to bias the resistance circuit. When two of the LCD driver integrated circuits are used, non-inversion input terminals of pairs of one of the plurality of voltage buffers in one of the two LCD driver integrated circuits and corresponding one of the plurality of voltage buffers in the other of the two LCD driver integrated circuits are connected in common to the reference voltage generating circuit, and a part of the connection terminals in one of the two LCD driver integrated circuits and a corresponding part of the connection terminals in the other of the two LCD driver integrated circuits are connected to each other.

### BACKGROUND OF THE INVENTION

1. Field of the Invention

The present invention relates to a grayscale voltage generating circuit, a driver integrated circuit (IC) and a liquid crystal display apparatus, and more particularly relates to a liquid crystal display in which pixels are driven by a driver IC with a grayscale voltage generating circuit.

2. Description of the Related Art

In recent years, the number of grayscale levels in a color liquid crystal display (LCD) has been increased from 260,000 color levels in 6-bit representation to 16,700,000 color levels in 8-bit representation. Moreover, a product of 1,000,000,000 color levels in 10-bit representation has been developed. In such a situation, a grayscale voltage generating circuit is one of important basic circuits to generate voltages matched to γ characteristic of each liquid crystal panel. Conventionally, a grayscale power supply IC is provided independently from the IC for the LCD driver IC and is used to adjust the γ characteristic of the liquid crystal display driver (hereafter, to be referred to as an LCD driver).

However, the grayscale voltage generating circuit is built in each of a plurality of LCD driver ICs to reduce the cost of the liquid crystal display apparatus. In this case, the grayscale voltages outputted from the respective liquid crystal driver ICs indicate values different from each other, depending on offset voltages caused due to amplifiers of the grayscale power supply circuits. Thus, a problem of a display block unevenness is caused. In particular, in case that a LCD driver is stuck on COG (Chip On Glass) and wirings are formed, its wiring resistance is large. Thus, the γ characteristic changes for each LCD driver IC, depending on a current flowing through a γ resistance determining the γ characteristic. Therefore, this becomes a large factor involving the display block unevenness.

In operational amplifiers for a grayscale voltage generating circuit, typically, a 6-bit product has five amplifiers on a positive side and five amplifiers on a negative side. Also, an 8-bit product has nine amplifiers on a positive side and nine amplifiers on a negative side. In these amplifiers, a power supply efficiency is considered and its output voltage is in a range of a power supply voltage or a voltage close to the ground voltage (GND). Also, the grayscale voltage generating circuit is provided as a dedicated IC outside the LCD driver IC in many cases. However, there is a case that it is built in the LCD driver IC. In this case, since the amplifier must be composed of CMOS transistors, the driving performance of a driver is limited.

FIG. 1 is a block diagram showing the configuration of a conventional LCD source driver 1100A and a conventional LCD panel 1300. With reference to FIG. 1, the LCD source driver 1100A in the conventional example has a data register 11 for receiving 6-bit digital display data R, G and B, a latch circuit 12 for latching the digital display data in synchronization with a strobe signal ST, a D/A converter 13 composed of n-stage digital/analog converting circuits provided in parallel, a grayscale voltage generating circuit 14 for generating grayscale voltages having γ characteristic based on the characteristic of the LCD panel, and an output amplifier section 15 for buffering a voltage outputted from the D/A converter 13. Here, the output amplifier section 15 has n voltage followers 15₁ to 15ₙ.

The LCD panel 1300 has thin film transistors (TFTs) 16₁ to 16ₙ provided at the intersection regions between data lines and scanning lines. Also, pixel capacitances 17₁ to 17ₙ are connected to the TFTs 16₁ to 16ₙ. Here, gates of the TFTs 16₁ to 16ₙ are connected to the scanning lines, and sources thereof are connected to the data lines. Also, ends of the pixel capacitances 17₁ to 17ₙ on one side are connected to drains of the TFTs 16₁ to 16ₙ, and ends on the other side are connected to a COM node. FIG. 1 shows the TFTs 16₁ to 16ₙ connected to one scanning line and the pixel capacitances 17₁ to 17ₙ. Usually, the LCD panel 1300 has a plurality of scanning lines. The TFTs 16₁ to 16ₙ are connected to this scanning line and the data lines, and the pixel capacitances 17₁ to 17ₙ are provided in the shape of an array. An LCD gate driver (not shown) sequentially drives the gates of the TFTs 16₁ to 16ₙ connected to the scanning lines one by one. The D/A converter 13 performs D/A conversion on the 6-bit digital display data latched by the latch circuit 12 and sends to N voltage followers 15₁ to 15ₙ. Then, the D/A converter 13 sends data signals through the TFTs 16₁ to 16ₙ to pixels as the pixel capacitances 17₁ to 17ₙ. Here, the grayscale voltage generating circuit 14 generates grayscale voltages as reference voltages for the data signal supplied on the data line. In the D/A converter 13, one of the grayscale voltages is selected by a decoder composed of a ROM switch (not shown). In a conventional grayscale voltage generating circuit disclosed in Japanese Patent No. 2590456 (first conventional example), a resistance ladder circuit is provided. This resistance ladder circuit is driven by voltage followers, in order to reduce impedance at an output node of each grayscale voltage and finely adjust the voltage value of the grayscale voltage.

FIG. 2 is a block diagram showing the configuration of the conventional grayscale voltage generating circuit 14. With reference to FIG. 2, the grayscale voltage generating circuit 14 is provided with a resistance ladder circuit 1102 built in an LCD source driver 1100A, an external resistance ladder circuit 1401 provided outside the LCD source driver 1100A; a buffer amplifier section 1101 having a plurality of operational amplifiers OP₁ to OPₙ functioning as voltage followers; and a constant voltage generating circuit for outputting a reference voltage Vᵣ. Here, the built-in resistance ladder circuit 1102 has resistances R₁ to Rₙ₋₁ connected in series and respectively connected to the output ends of the operational amplifiers OP₁ to OPₙ. Also, the external resistance ladder circuit 1401 has the constant voltage generating circuit and resistances R_{0′} to Rₙ₋₁, connected in series. The resistances R_{0′} to Rₙ₋₁, are connected to non-inversion input terminals of the operational amplifiers OP₁ to OPₙ.

The operational amplifiers OP₁ to OPₙ output grayscale voltages V_{g1} to V_{gn} based on tap voltages of the resistances R_{0′} to Rₙ₋₁, in the external resistance ladder circuit 1401. Here, the resistances R_{0′} to R_{n-1′} in the external resistance ladder circuit 1401 are variable resistances. By changing those resistance values, the tap voltages applied to the operational amplifiers OP₁ to OPₙ are adjusted. At this time, the voltages applied to the operational amplifiers OP₁ to OPₙ are adjusted such that the grayscale voltages V_{g1} to V_{gn} outputted from the external resistance ladder circuit 1401 are the optimal voltages for the characteristic of the LCD panel 1300.

The reference voltage Vᵣ is supplied to the grayscale voltage generating circuit 14. The reference voltage Vᵣ is generated by a stable external constant voltage generating circuit such as a band gap reference. The grayscale voltages V_{gn}, V_{gn-1}, V_{gn-2}, ---, V_{g2} and V_{g1} are finally determined based on the ladder resistances R_{0′}, R_{1′}, R_{2′}, ---, R_{n-2′} and R_{n-1′}, respectively. That is, the grayscale voltages V_{gn}, V_{gn-1}, V_{gn-2}, ---, V_{g2} and V_{g1} are determined as follows.
V_{gn}=VᵣV_{gn-1}=Vᵣ{(Rₙ₋₂,+Rₙ₋₃,+ . . . +R_{0′})/(R_{n-1′}+R_{n-2′}+R_{n-3′},+ . . . +R_{0′})}, . . . ,
V_{g1}=Vᵣ{R_{0′}/(R_{n-1′},+R_{n-2′}+R_{n-3′}+ . . . +R_{0′})}
Here, if a resistance ratio of the resistances R₁ to Rₙ₋₁ to determine the grayscale voltages V_{g1} to V_{gn} in an LCD source driver 10 and a resistance ratio of the resistances R_{1′} to R_{n-1′} to determine the grayscale voltages V_{g1} to V_{gn} are equal to each other, the output currents of the operational amplifiers OP₂ to OPₙ₋₁ become zero.

However, an output current Iₙ in the n-th operation amplifier OPₙ (the operational amplifier that outputs the maximum grayscale voltage V_{gn}) is given by the following equation (1) in a discharge direction
Iₙ=(V_{gn}−V_{g1})/(R₁+R₂+ . . . +Rₙ₋₁ (1)
Also, an output current I₁ of the first operational amplifier OP₁ (the operational amplifier that outputs the minimum grayscale voltage V_{g1}) is given by the following equation (2) in the discharge direction.
I₁=(V_{gn}−V_{g1})/(R₁+R₂+ . . . +Rₙ₋₁) (2)
Thus, the operation amplifier OPₙ and the operation amplifier OP₁ need to be designed as the output stages that can output the output currents Iₙ and I₁, respectively. In particular, when they are designed by using MOS transistors, a mutual conductance gm of the MOS transistor which determines a drive performance is small as compared with a bipolar transistor. Therefore, attention should be paid thereto.

Also, Japanese Laid Open Patent Application (JP-A-Heisei 10-142582: second conventional example) discloses a technique in which reduction in an output dynamic range of an operational amplifier is improved in a liquid crystal grayscale voltage generating circuit.

Also, an LCD driver in which a plurality of LCD driver ICs are connected in parallel to increase the number of grayscale levels to be displayed on a liquid crystal is disclosed in Japanese Laid Open Patent Application (JP-A-Heisei 5-119744: third conventional example). FIG. 3 is a block diagram showing the configuration of an LCD source driver 1100B using two LCD source driver ICs, each of which has a built-in grayscale voltage generating circuit. With reference to FIG. 3, the LCD source driver 1100B has a first LCD source driver IC 110-1 and a second LCD source driver IC 110-2. The first LCD source driver IC 110-1 is provided with a grayscale voltage generating circuit 14′-1, a data register 11-1, a latch circuit 12-1, a D/A converter 13-1 and an output amplifier section 15-1. The grayscale voltage generating circuit 14′-1 is provided with a negative side grayscale resistance group 142-1 composed of a group of resistances R₁-1 to R_{(n/2)-1}-1 and a positive side grayscale resistance group 141-1 composed of a group of resistances R_{(n/2)+1}-1 to Rₙ₋₁-1; operational amplifiers 143₁-1 and 143₂-1 which are connected to the negative side grayscale resistance group 142-1; and operational amplifiers 143₃-1 and 143₄-1 which are connected to the positive side grayscale resistance group 141-1. The configuration of the second LCD source driver IC 110-2 is similar to that of the first LCD source driver IC 110-1. The reference numerals of the similar components are used in which an additional number “1” of the component of the first LCD source driver IC 110-1 is replaced with “2”.

The non-inversion input terminals of the operational amplifiers 143₄-1 and 143₄-2 are connected to a first constant voltage source V_{H+} and the non-inversion input terminals of the operational amplifiers 143₃-1 and 143₃-2 are connected to a second constant voltage source V_{L+} for supplying a voltage lower than the first constant voltage source V_{H+}. Thus, the operational amplifier 143₄-1 supplies the highest voltage to the positive side grayscale resistance group 141-1. Similarly, the operational amplifier 143₄-2 supplies the highest voltage to the positive side grayscale resistance group 141-2. Also, the operational amplifier 143₃-1 supplies the lowest voltage to the positive side grayscale resistance group 141-1. Similarly, the operational amplifier 143₃-2 supplies the lowest voltage to the positive side grayscale resistance group 141-2. Moreover, the non-inversion input terminals of the operational amplifiers 143₂-1 and 143₂-2 are connected to a third constant voltage source V_{H-}, and the non-inversion input terminals of the operational amplifiers 143₁-1 and 143₁-2 are connected to a fourth constant voltage source V_{L-} for supplying a voltage lower than the third constant voltage source V_{H-}. Thus, the operational amplifier 143₂-1 supplies the highest voltage to the negative side grayscale resistance group 142-1. Similarly, the operational amplifier 143₂-2 supplies the highest voltage to the negative side grayscale resistance group 142-2. Also, the operational amplifier 143₁-1 supplies the lowest voltage to the negative side grayscale resistance group 142-1. Similarly, the operational amplifier 143₁-2 supplies the lowest voltage to the negative side grayscale resistance group 142-2. Also, when the two or more LCD source driver ICs are used, the non-inversion input terminals of the operational amplifiers are commonly connected to the power supply voltages, respectively.

In the first to fourth constant voltage sources V_{H+}, V_{L+}, V_{H-} and V_{L-}, since they are usually constituted to use resistance division, their impedances are high. Thus, buffer amplifiers are required. In this example, the operational amplifiers 143₁ to 143₄ carry out the roles as the buffer amplifiers. The LCD panel changes the brightness in response to the output from the LCD source driver 1100B having such a configuration. For example, in the LCD panel of a normally white type, the values of the first to fourth constant voltage sources V_{H+}, V_{L+}, V_{H-} and V_{L-} are set such that the high voltage side of the positive side grayscale corresponds to a black level, the low voltage side corresponds to a white level, the low voltage side of the negative side grayscale corresponds to the black side, and the high voltage side corresponds to the white level.

As mentioned above, in the conventional technique, the LCD source driver contains the plurality of LCD source driver ICs. In this case, a variation in the ladder resistances is caused in each LCD source driver IC. Accordingly, the grayscale characteristic is different among the respective driver ICs, and a problem of the display block unevenness is caused. Moreover, the difference in the offset voltage of the operational amplifier for the grayscale voltage generating circuit, which is built in the LCD driver, causes the generation of the grayscale voltage that is different between the LCD source driver ICs. Therefore, there is a possibility that the problem of the display block unevenness is caused. In detail, the grayscale voltage is determined based on resistance division in each LCD source driver IC. A resistance division ratio is varied for each LCD source driver IC, although this is natural. As a result, the grayscale characteristics of the first LCD source driver IC 110-1 and second LCD source driver IC 110-2 are different. In this case, if the two driver ICs are arranged systematically and the liquid crystal panel is driven in response to the data signals based on the respective grayscale voltages, the boundary between the LCD panels driven by the respective driver ICs can be recognized by a human's eye. It should be noted that the human's eye is said to be possible to recognize the difference of 10 mV in the voltage applied to the liquid crystal, as the different grayscale.

In order to solve the above problems, the outputs of the grayscale power supply operational amplifiers are considered to be commonly connected. However, in the conventional technique, the offset voltages of the respective operational amplifiers are different. Thus, if the outputs are short-circuited, the power supply operational amplifier is abnormally operation. For this reason, it is difficult to connect the outputs of the grayscale power supply operational amplifiers to each other. Therefore, in the conventional examples, it is difficult to commonly connect the LCD driver ICs in which the grayscale voltage generating circuits are built.

### SUMMARY

In an aspect of the present invention, a liquid crystal display (LCD) driver integrated circuit includes a grayscale voltage generating circuit configured to generate a plurality of grayscale voltages from a set of supply reference voltages; and a converting section having connection terminals and configured to drive each of a plurality of data lines of a liquid crystal display panel through one of the connection terminals based on one of the plurality of grayscale voltages which is determined based on an input data, when each of a plurality of scanning lines of the liquid crystal display panel is driven. The grayscale voltage generating circuit includes a resistance circuit having resistances connected in series; and a plurality of voltage buffers connected to the resistance circuit to bias the resistance circuit. When two of the LCD driver integrated circuits are used, non-inversion input terminals of pairs of one of the plurality of voltage buffers in one of the two LCD driver integrated circuits and corresponding one of the plurality of voltage buffers in the other of the two LCD driver integrated circuits are connected in common to the reference voltage generating circuit, and a part of the connection terminals in one of the two LCD driver integrated circuits and a corresponding part of the connection terminals in the other of the two LCD driver integrated circuits are connected to each other.

Here, the plurality of voltage buffers includes two voltage buffers connected to ends of the resistance circuit.

Also, the grayscale voltage generating circuit may further include a protection resistance connected between the resistance circuit and an output of each of the two voltage buffers.

Also, all of the connection terminals in one of the two LCD driver integrated circuits and all of the connection terminals in the other of the two LCD driver integrated circuits may be connected to each other.

Also, all of the connection terminals other than the connection terminal corresponding to the ends in one of the two LCD driver integrated circuits and all of the connection terminals other than the connection terminal corresponding to the ends in the other of the two LCD driver integrated circuits may be connected to each other.

In this case, the grayscale voltage generating circuit may include the plurality of voltage buffers connected to nodes between the resistances of the resistance circuit to bias the resistance circuit. The reference voltage generating circuit may generate the set of supply reference voltages for the plurality of voltage buffers.

In another aspect of the present invention, an liquid crystal display (LCD) apparatus includes an LCD panel having a plurality of data lines and a plurality of scanning lines, wherein pixels are provided at intersections of the plurality of data lines and the plurality of scanning lines; a reference voltage generating circuit configured to generate a set of supply reference voltages; and two driver integrated circuits connected to each other through the plurality of data lines. Each of the plurality of driver integrated circuits includes a grayscale voltage generating circuit configured to generate a plurality of grayscale voltages from the set of supply reference voltages; and a converting section having connection terminals and configured to drive each of the plurality of data lines through one of the connection terminals based on one of the plurality of grayscale voltages which is determined based on an input data, when each of the plurality of scanning lines is driven. The grayscale voltage generating circuit includes a resistance circuit having resistances connected in series; and a plurality of voltage buffers connected to the resistance circuit to bias the resistance circuit. Non-inversion input terminals of pairs of one of the plurality of voltage buffers in one of the two driver integrated circuits and corresponding one of the plurality of voltage buffers in the other of the two driver integrated circuits are connected in common to the reference voltage generating circuit. At least a part of the connection terminals in one of the two driver integrated circuits and a corresponding part of the connection terminals in the other of the two driver integrated circuits are connected to each other.

According to the present invention, it is possible to improve the image quality of the liquid crystal displaying panel that is driven by using the plurality of driver ICs. Also, it is possible to improve the displaying trouble (block unevenness) in the liquid crystal displaying panel.

### BRIEF DESCRIPTION OF THE DRAWINGS

FIG. 1 is a block diagram showing a configuration of a conventional liquid crystal display apparatus;

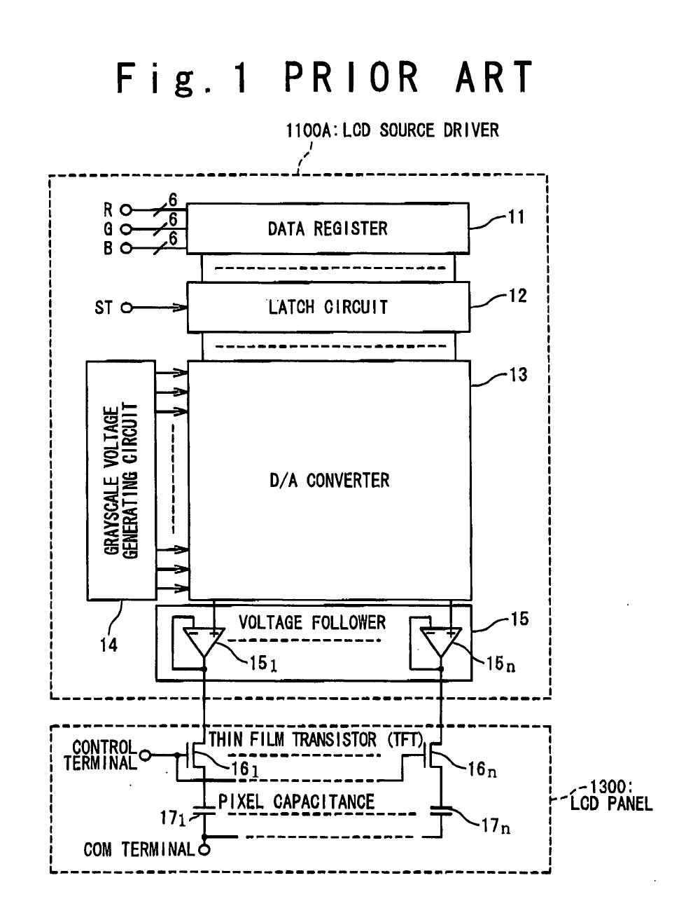

FIG. 2 is a block diagram showing a configuration of a grayscale voltage generating circuit in the conventional liquid crystal display apparatus;

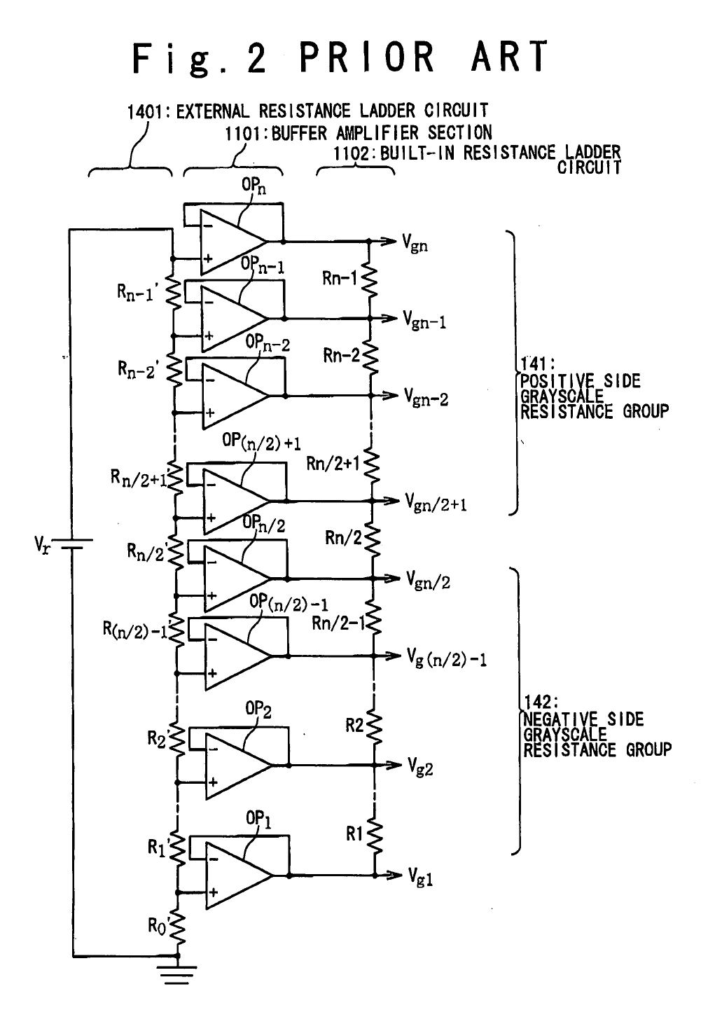

FIG. 3 is a block diagram showing a configuration of a plurality of LCD source driver ICs according to a conventional liquid crystal display apparatus;

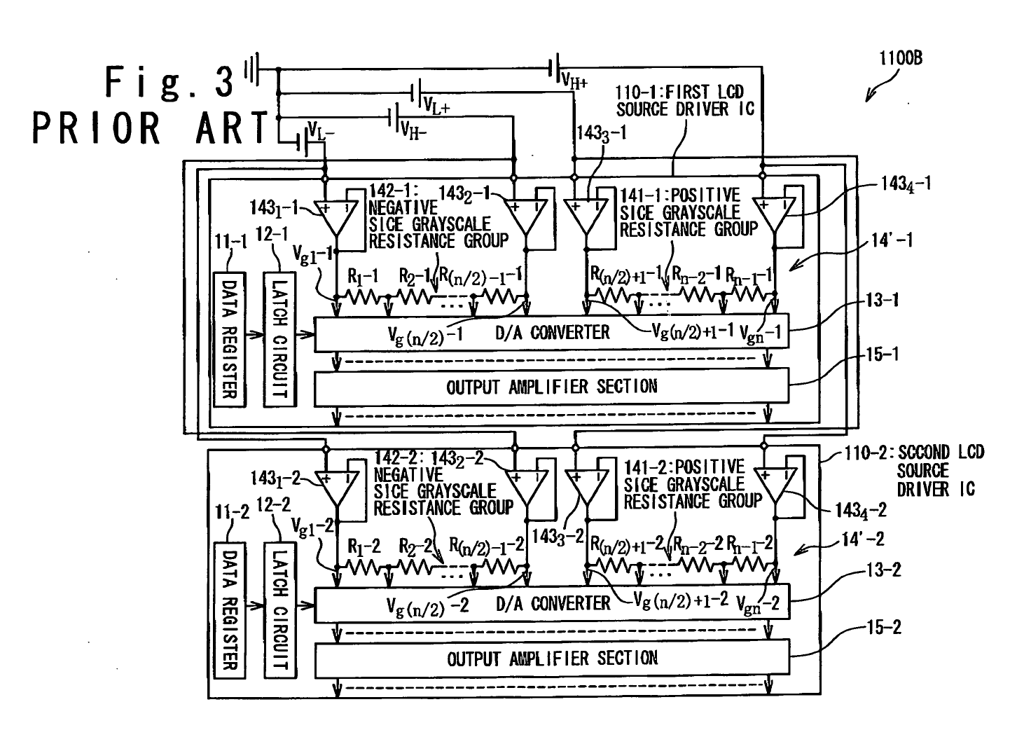

FIG. 4 is a block diagram showing a configuration of a liquid crystal display according to the present invention;

FIG. 5 is a block diagram showing a configuration of an LCD source driver according to a first embodiment of the present invention;

FIG. 6 is a block diagram showing a configuration of the LCD source driver according to a second embodiment of the present invention;

FIG. 7 is a block diagram showing a configuration of a grayscale voltage generating circuit according to the second embodiment of the present invention; and

FIG. 8 is a block diagram showing a configuration of the LCD source driver according to a third embodiment of the present invention.

### DESCRIPTION OF THE PREFERRED EMBODIMENTS

Hereinafter, a liquid crystal display apparatus containing a source driver with a grayscale voltage generating circuit according to the present invention will be described in detail with reference to the attached drawings. In the drawings, the same or similar reference numerals and symbols indicate the same, similar or equivalent components.

(Configuration of Liquid Crystal Display Apparatus)

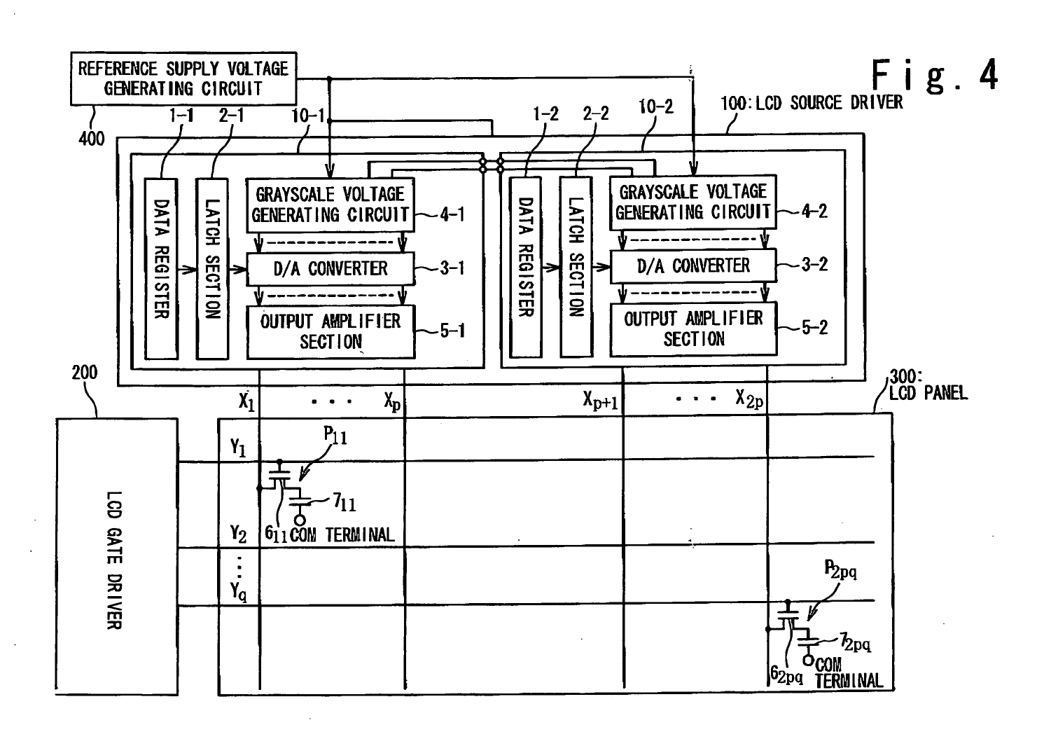

FIG. 4 is a block diagram showing the configuration of the liquid crystal display apparatus according to the first embodiment of the present invention. With reference to FIG. 4, the liquid crystal display apparatus according to the present invention has an LCD (Liquid Crystal Display) source driver 100, an LCD gate driver 200, an LCD panel 300 and a reference voltage generating circuit 400. On the LCD panel 300, there are a plurality of data lines X₁ to X₂ₚ (p is a natural number of 2 or more) arrayed in a row direction; a plurality of scanning lines Y₁ to Y_{q} (q is a natural number of 2 or more) arrayed in a column direction, and pixels P₁₁ to P_{2qp} provided in regions in which the data lines X₁ to X₂ₚ and the scanning lines Y₁ to Y_{q} intersect. Here, the pixels P₁₁ to P_{2qp} have TFTs (Thin Film Transistor) 6₁₁ to 6_{2pq} and pixel capacitances 7₁₁ to 7_{2pq}. The gates of the TFTs 6₁₁ to 6_{2pq} are connected to the scanning lines Y₁ to Y_{q}, and sources are connected to the data lines X₁ to X_{2pq}. Also, ends of the pixels 7₁₁ to 7_{2pq} on one side are connected to drains of the TFTs 6₁₁ to 6_{2pq}, and the other ends thereof are connected through a COM terminal to a common electrode. Hereinafter, for example, the pixel provided at the position at which the data line Xₚ and the scanning line Y_{q} intersect is referred to as the pixel P_{pq}.

The LCD source driver 100 has a plurality of LCD source driver ICs 10 and drives the data lines X in the LCD panel 300. The LCD source driver 100 in this embodiment has two LCD source driver ICs 10-1 and 10-2 as an example. The LCD source driver IC 10-1 outputs data signals to drive the data lines X₁ to Xₚ. The LCD source driver IC 10-2 outputs the data signals to drive the data lines Xₚ₊₁ to X₂ₚ. Hereinafter, the additional numbers “−1” and “−2” are added to the components provided in the LCD source drivers ICs 10-1 and 10-2. Also, when the LCD source driver IC 10-1 and the LCD source driver IC 10-2 are not discriminated, they will be described under the assumption that the additional numbers are not added.

Each LCD source driver IC 10 is provided with a data register 1 for acquiring digital display data R, G and B; a latch circuit 2 for latching the digital display data in synchronization with a strobe signal ST; a D/A converter 3 composed of digital/analog converting circuits of n parallel stages; a grayscale voltage generating circuit 4 having a gamma conversion characteristic corresponding to a characteristic of a liquid crystal; and an output amplifier section 5 for buffering a voltage outputted from the D/A converter 3.

The grayscale voltage generating circuit 4 generates grayscale voltages V_{g1} to V_{gn} serving as the reference voltages for the data signals that indicates the grayscale of each pixel P. In accordance with the reference voltages supplied from the reference voltage generating circuit 400 provided outside the LCD source driver 100, the grayscale voltage generating circuit 4 applies the grayscale voltages V_{g1} to V_{gn} to the D/A converter 3. The number n of grayscale voltages V_{g1} to V_{gn} is arbitrary. However, in case of a 6-bit product, for example, when n=10, the grayscale voltages V_{g1} to V₁₀ are outputted. Here, although it is omitted, the grayscale voltage V_{g} is divided by the resistances and outputted to the D/A converter 3. In case of the 6-bit product, the grayscale voltages corresponding to 64 grayscale levels based on the resistance division are outputted to the D/A converter 3. In the D/A converter 3, the grayscale voltage is selected by a decoder composed of ROM switches (not shown). Also, the selected grayscale voltage is converted into a display signal that is an analog signal, and amplified by the output amplifier section 5 and outputted to each data line X, and each pixel P is driven.

As described later, a part or all of nodes N in which the grayscale voltages are generated in the grayscale voltage generating circuit 4 according to the present invention is commonly connected to a part or all of nodes N in which the grayscale voltages are generated by a different grayscale voltage generating circuit 4, and have the same voltage. For this reason, the magnitudes of the display signals based on the same grayscale voltage outputted by the adjacent LCD driver ICs 10-1 and 10-2 can be made uniform, thereby improving the block unevenness. That is, one feature of the present invention is in the configuration in which the nodes having the grayscale voltages determined based on the resistance division are commonly connected and set at the same voltage between the plurality of driver ICs. The present invention will be described below in detail in the first to third embodiments.

### First Embodiment

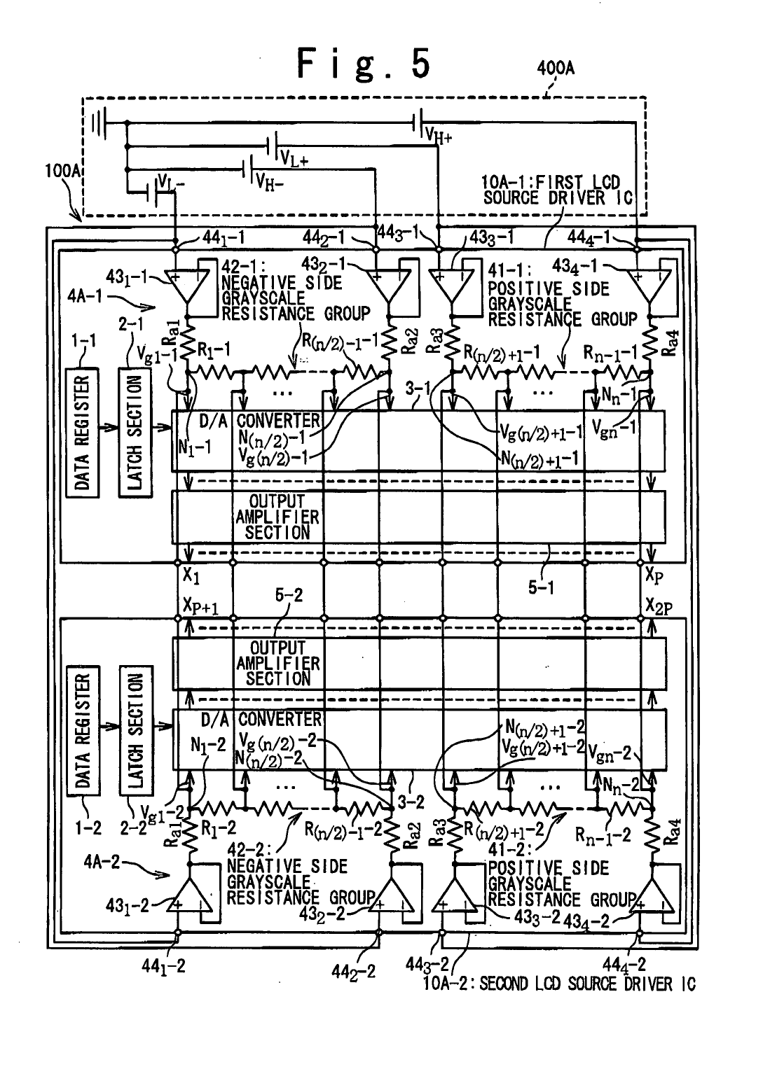

The liquid crystal display according to the first embodiment of the present invention will be described below with reference to FIGS. 4 and 5. The liquid crystal display in the first embodiment is configured in such a manner that the LCD source driver 100 shown in FIG. 4 is defined as an LCD source driver 100A, and the reference voltage generating circuit 400 is defined as a reference voltage generating circuit 400A.

FIG. 5 is a block diagram showing the configuration of the LCD source driver 100A in the first embodiment. With reference to FIG. 5, the LCD source driver 100A has a first LCD source driver IC 10-1 and a second LCD source driver IC 10-2. An LCD source driver IC 10A has a grayscale voltage generating circuit 4A, the data register 1, the latch section 2, the D/A converter 3 and the output amplifier section 5.

The grayscale voltage generating circuit 4A is provided with a positive side grayscale resistance group 41, a negative side grayscale resistance group 42, four operational amplifiers 43₁ to 43₄ that are the operational amplifier circuits forming voltage followers, and four resistances Rₐ₁ to Rₐ₄. The negative side grayscale resistance group 42 is composed of resistances R₁ to R_{(n/2)-1}. The resistances R₁ to R_{(n/2)-1} are connected in series through nodes N₂ to N_{(n/2)-1}, in turns. Also, one end of the R₁ that is not connected to the resistance R₂ is connected through the node N₁ to the resistance Rₐ₁, and one end of the R_{(n/2)-1} that is not connected to the resistance R_{(n/2)-2} is connected through the node N_{(n/2)} to the resistance Rₐ₂. The positive side grayscale resistance group 41 is composed of resistances R_{(n/2)+1} to Rₙ₋₁. The resistances R_{(n/2)+1} to Rₙ₋₁ are connected in series through the nodes N_{(n/2)+2} to Nₙ₋₁ in turn. Also, one end of the resistance R_{(n/2)+1} that is not connected to the resistance R_{(n/2)+2} is connected through the node N_{(n/2)+1} to the resistance Rₐ₃ and one end of the resistance Rₙ₋₁ that is not connected to the resistance Rₙ₋₂ is connected through the node Nₙ to the resistance Rₐ₄.

The output ends of the operational amplifiers 43₁ and 43₂ are connected through the resistances Rₐ₁ and Rₐ₂ to the nodes N₁, N_{(n/2)} of the negative side grayscale resistance group, respectively. Also, the output ends of the operational amplifiers 43₃ and 43₄ are connected to the nodes N_{(n/2)+1} and Nₙ of the positive side grayscale resistance group through the resistances Rₐ₃ and Rₐ₄ respectively. Here, the reference voltage generating circuit 400A has constant voltage sources V_{H+}, V_{L+}, V_{H-} and V_{L-}. A non-inversion input terminal 44₄ of the operational amplifier 43₄ is connected to the constant voltage source V_{H+}, and a non-inversion input terminal 44₃ of the operational amplifier 43₃ is connected to the constant voltage source V_{L+} that supplies a voltage lower than the first constant voltage source V_{H+}. Thus, the operational amplifier 43₄ supplies the highest voltage in the positive side grayscale resistance group 41 to the node Nₙ. Similarly, the operational amplifier 43₃ supplies the lowest voltage in the positive side grayscale resistance group 41 to the node N_{(n/2)+1}. Moreover, a non-inversion input terminal 44₂ of the operational amplifier 43₂ is connected to the third constant voltage source V_{H-}, and a non-inversion input terminal 44₁ of the operational amplifier 43₁ is connected to the fourth constant voltage source V_{L-} that supplies a voltage lower than the third constant voltage source V_{H-}. Thus, the operational amplifier 43₃ supplies the highest voltage in the negative side grayscale resistance group 42 to the node N_{(n/2)}. Similarly, the operational amplifier 43₁ supplies the lowest voltage in the negative side grayscale resistance group 42 to the node N₁. As for the magnitudes of the reference voltages supplied from the constant voltage sources V_{H+}, V_{L+}, V_{H-} and V_{L-}, for example, in the LCD panel of the normally white type, the values of the first to fourth voltages V_{H+}, V_{L+}, V_{H-} and V_{L-} are set such that the high voltage side of the positive side grayscale resistance group 41 corresponds the white level, the low voltage side corresponds to the black level, the low voltage side of the negative side grayscale resistance group 42 corresponds to the black level, and the high voltage side corresponds to the white level.

The negative side grayscale resistance group 42 and the positive side grayscale resistance group 41 are connected to the D/A converter 3 through the nodes N₁ to Nₙ. The respective nodes N₁ to Nₙ supply the grayscale voltages V_{g1} to V_{gn}, which are based on the voltages supplied from the operational amplifiers 43₁ to 43₄, to the D/A converter 3. On the other hand, the nodes N₁₋₁ to Nₙ-1 in the first LCD source driver IC 10A-1 and the nodes N₁-2 to Nₙ-2 in the corresponding second LCD source driver IC 10A-2 are commonly connected. Thus, the grayscale voltages V_{g1}-1 to V_{gn}-1 in the first LCD source driver IC 10A-1 and the grayscale voltages V_{g1}-2 to V_{gn}-2 in the second LCD source driver IC 10A-2 have the same voltages, respectively.

As mentioned above, in the LCD source driver 100A according to the present embodiment, the non-inversion input terminals 44-1 and 44-2 of the respective operational amplifiers 43-1 to 43-2 in the two LCD source driver ICs 10A-1 and 10A-2 are commonly connected to the reference voltage generating circuit 400A, and between the two LCD source driver ICs 10A-1 and 10A-2, they are connected in parallel to the nodes N₁-1 to Nₙ-1 and the nodes N₁-2 to Nₙ-2 that supply the grayscale voltages V_{g1} to V_{gn}. Also, the resistance Rₐ for preventing the abnormal current from flowing due to the shorted state between the output ends of the operational amplifiers 43-1 and 43-2 is provided between the operational amplifier 43 and the positive side grayscale resistance group 41 and the negative side grayscale resistance group 42, in each LCD source driver IC 10A.

(operation of LCD Source Driver 100A in First Embodiment)

With reference to FIG. 5, this shows a design example of a resistance value of the resistance Rₐ. Here, the design example of the resistance value of the resistance Rₐ is indicated by paying attention to the grayscale voltage V_{gn} at the node Nₙ. A voltage value of the grayscale voltage V_{gn} is assumed to be V₊₁. That is, the voltage values of the nodes Nₙ-1 and Nₙ-2 that are a common connection point of the LCD source driver IC 10 are assumed to be V₊₁. Also, an offset voltage of the operational amplifier 43₄-1 in the first LCD source driver IC 10A-1 is assumed to be V_{IO1}, an offset voltage of the operational amplifier 43₄-2 in the second LCD source driver IC 10A-2 is assumed to be V_{IO2}, a resistance value of the resistance Rₐ₄ added to the output of the operational amplifier 43₄ is assumed to be Rₐ, and the total resistance value in all of the resistances R_{(n/2)+1} to Rₙ₋₁ in the positive side grayscale resistance group 41 is assumed to be R₊₁. Moreover, when the influences of the offset voltage of the operational amplifier 43₃ and the additional resistance Rₐ₃ connected to the output of the operational amplifier 43₃ are ignored, the voltage value at the node N_{(n/2)+1} becomes V_{L+}. Here, when the law of [superposition Principle] is used, the V₊₁ is calculated as follows.

$$\begin{matrix}{V}_{+ 1} = ( {V}_{H +} + {V}_{I 01} ) \frac{{R}_{a} // ( {R}_{+ 1} / 2 )}{{R}_{a} + {R}_{a} // ( {R}_{+ 1} / 2 )} + \\ ( {V}_{H +} + {V}_{I 02} ) \frac{{R}_{a} // ( {R}_{+ 1} / 2 )}{{R}_{a} + {R}_{a} // ( {R}_{+ 1} / 2 )} + {V}_{L +} \frac{{R}_{a}}{{R}_{a} + {R}_{+ 1}}\end{matrix}$$

Here, in the actual design, Rₐ<<R₊₁. Thus, Rₐ//(R₊₁/2)≈Ra. Therefore, the V₊₁ is approximately represented by the equation (2).

$${V}_{+ 1} ≡ {V}_{H +} \frac{{V}_{I 01} + {V}_{I 02}}{2}$$

The equation (2) indicates that the value V₊₁ of the grayscale voltage V_{g}, which is supplied to the D/A converter 3 from the node Nₙ, is the value where an average value (V_{IO1}+V_{IO2})/2 of the offset voltages in the two operational amplifiers 43₄-1 and 43₄-2 is added to the reference voltage V_{H+}. That is, the offset voltages of the grayscale power supply operational amplifiers in the respective LCD source driver ICs 10A-1 and 10A-2 are averaged, and the displaying grayscale is determined at the common grayscale voltage. Thus, even if the different LCD source driver ICs 10A-1 and 10A-2 drive the data lines X in response to the grayscale voltage based on the same reference supply power supply, the display block unevenness is never generated in the LCD panel 300.

The current value flowing through the operational amplifier 43 will be verified below. When the output current value flowing through the operational amplifier 43 is assumed to be I_{Ra1}, this is represented by the equation (3).

$${I}_{Ra 1} = \frac{{V}_{H +} + {V}_{I 01} - ( {V}_{H +} + \frac{{V}_{I 01} + {V}_{I 02}}{2} )}{{R}_{a}} = \frac{{V}_{I 01} - {V}_{I 02}}{2 {R}_{a}}$$

Here, the output current value I_{Ra1} flowing through the operational amplifier 43 is required to be within the drive current range of the operational amplifier 43. For example, if the value (V_{IO1}-V_{IO2}) in the above equation is assumed to be 20 mV at maximum and Rₐ is assumed to be 100Ω, I_{Ra1} becomes 100 μA.

In this way, the value of the resistance Rₐ is determined in accordance with the offset voltage in the operational amplifier 43. Naturally, as this resistance Rₐ is smaller, an error from the desirable grayscale voltage V_{g} becomes smaller. However, reversely, if it is too small, an unnecessary current caused by the offset voltage becomes large. That is, they have a trade-off relation. While they are considered, the resistance Rₐ is preferably optimally designed.

As mentioned above, since the resistance Rₐ is inserted into the output of the grayscale power supply operational amplifier 43, this has an effect of improving a phase margin for a capacitive load in the operational amplifier 43, in addition to the effect of preventing the abnormal current. This results from the improvement of the capacitance characteristic to the load, because the resistance is inserted outside the feedback loop of the operational amplifier 43.

### Second Embodiment

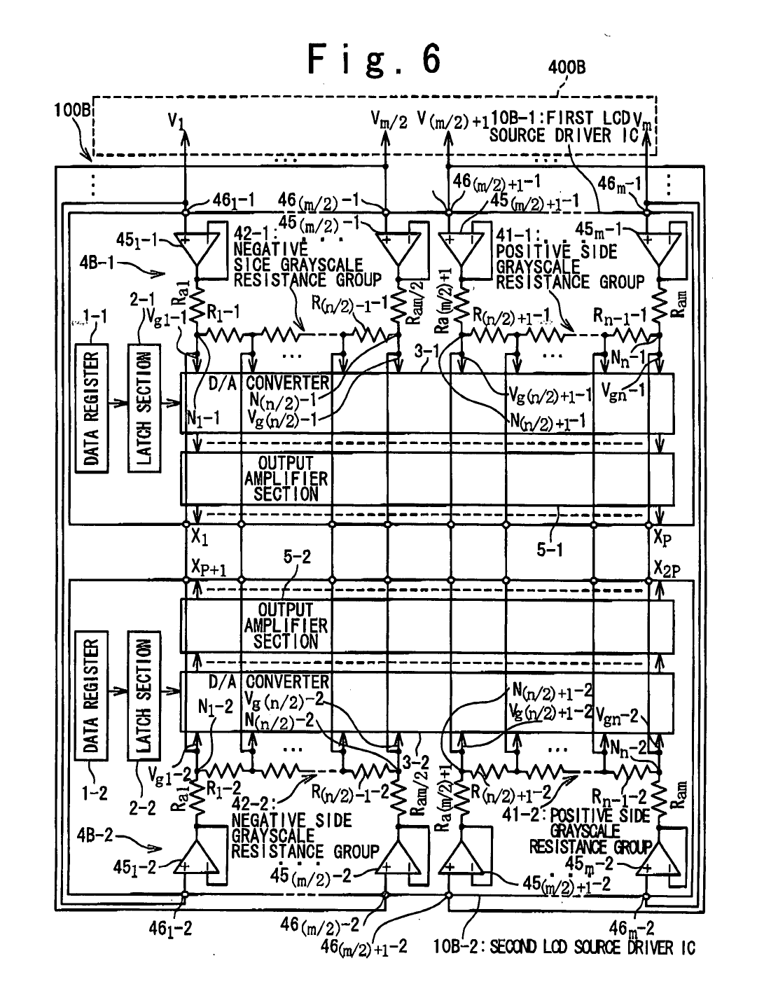

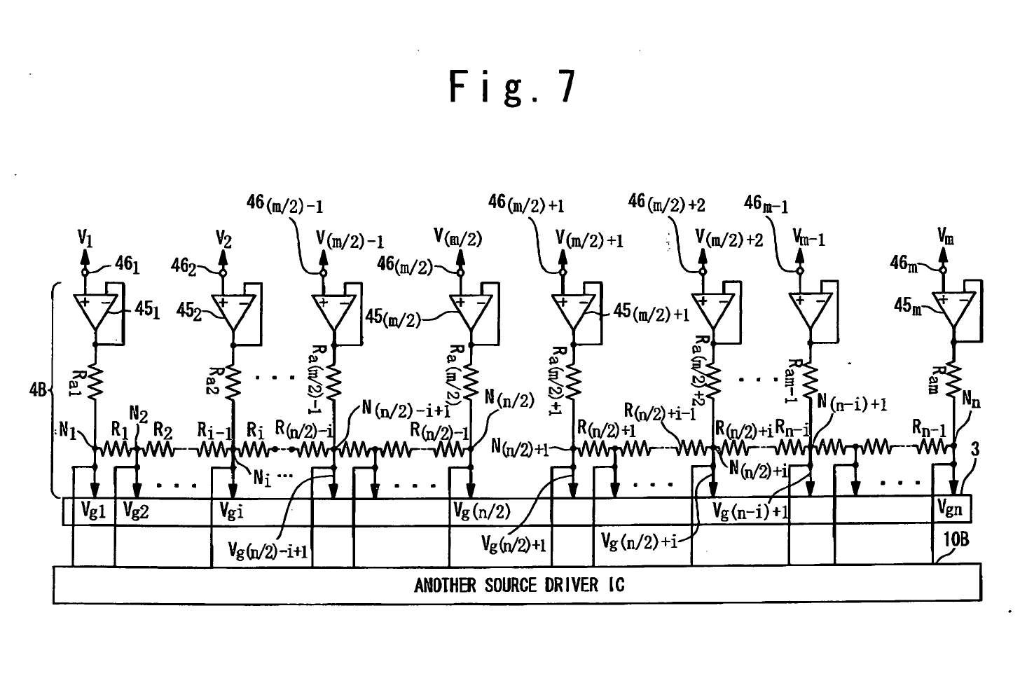

The liquid crystal display apparatus according to the second embodiment of the present invention will be described below with reference to FIGS. 6 and 7. The liquid crystal display apparatus in the second embodiment is configured such that the LCD source driver 100A and the reference voltage generating circuit 400A in the first embodiment are replaced with an LCD source driver 100B and a reference voltage generating circuit 400B, respectively.

FIG. 6 is a block diagram showing the configuration of the LCD source driver 100B in the second embodiment. FIG. 7 is a block diagram showing the detailed configuration of a grayscale voltage generating circuit 4B in the second embodiment. With reference to FIG. 6, the LCD source driver 100B has a first LCD source driver IC 10B-1 and a second LCD source driver IC 10B-2. The LCD source driver IC 10B has the grayscale voltage generating circuit 4B, the data register 1, the latch section 2, the D/A converter 3 and the output amplifier section 5.

The grayscale voltage generating circuit 4B has the positive side grayscale resistance group 41, the negative side grayscale resistance group 42, operational amplifiers 45₁ to 45ₘ that are the operational amplifiers forming the voltage followers, and resistances Rₐ₁ to Rₐₘ. The grayscale voltage generating circuit 4B in the second embodiment has the m operational amplifiers 45₁ to 45ₘ in which the number m of the operational amplifiers is equal to or less than the number n of the nodes N₁ to Nₙ in the positive side grayscale resistance group 41 and negative side grayscale resistance group 42 of the first embodiment. As for the number of the operational amplifiers 45, typically, a 6-bit product has a total of 10 (m=10) operational amplifiers 45, which are composed of five on the positive side and five on the negative side. Or, an 8-bit product has a total of 18 (m=18) operational amplifiers 45, which are composed of nine on the positive side and nine on the negative side. Also, the output ends of the operational amplifiers 45₁ to 45ₘ are connected through the resistances Rₐ₁ to Rₐₘ to any of the nodes N₁ to Nₙ. On the other hand, the reference voltage generating circuit 400B has m constant voltage sources V₁ to Vₘ. Non-inversion input terminals 46₁ to 46ₘ of the operational amplifiers 45₁ to 45ₘ are connected to the constant voltage sources V₁ to Vₘ. However, they are connected as mentioned above, between the resistance Rₐ, the operational amplifier 45, the non-inversion input terminal 46 and the constant voltage source V in which the same subscripts are assigned.

The negative side grayscale resistance group 42 and the positive side grayscale resistance group 41 are connected through the nodes N₁ to Nₙ to the D/A converter 3. The respective nodes N₁ to Nₙ supply the grayscale voltages V_{g1} to V_{gn}, which are based on the voltages from the operational amplifiers 45₁ to 45ₙ to the D/A converter 3. On the other hand, the nodes N₁-1 to Nₙ-1 in the first LCD source driver IC 10B-1 and the nodes N₁-2 to Nₙ-2 in the second LCD source driver IC 10B-2 are commonly connected. Thus, the grayscale voltages V_{g1}-1 to V_{gn}-1 in the first LCD source driver IC 10B-1 and the V_{g1}-2 to V_{gn}-2 in the second LCD source driver IC 10A-2 in which the subscript numbers correspond thereto have the same voltages, respectively.

As mentioned above, in the LCD source driver 100B according to the present embodiment, the non-inversion input terminal 46-1 of the operational amplifier 45-1 in the first LCD source driver IC 10B-1 and the non-inversion input terminal 46-2 of the operational amplifier 45-2 in the second LCD source driver IC 10B-2 are commonly connected to the corresponding power supply voltages V₁ to Vₘ in the reference voltage generating circuit 400B. Also, between the two LCD source driver ICs 10B-1 and 10B-2, the nodes N₁-1 to Nₙ-1 that supply the grayscale voltages V_{g1} to V_{gn} are connected in parallel to the corresponding nodes N₁-2 to Nₙ-2. Moreover, the resistance Rₐ for preventing the abnormal current from flowing due to the shorted state between the operational amplifiers 45-1 and 45-2 is provided between the node N connected to the output end of the operational amplifier 45 and the positive side grayscale resistance group 41 and the negative side grayscale resistance group 42.

The detailed configuration of the grayscale voltage generating circuit 4B according to the present invention will be described below with reference to FIG. 7. The output ends of the operational amplifiers 45 serving as the voltage follower are usually connected to the nodes N at a rate of one per several nodes. That is, the n grayscale voltages can be generated by the m reference power supplies. In detail, the output ends of the operational amplifiers 45₁ to 45_{(m/2)} are connected to every several nodes N from one end (the node N₁) to the other end (the node N_{(n/2)}) in the negative side grayscale resistance group 42. Similarly, the output ends of the operational amplifiers 45_{(m/2)+1} to 45ₘ are connected to every several nodes N from one end (the node N_{(n/2)+1}) to the other end (the node Nₙ) in the positive side grayscale resistance group 41. For example, the operational amplifier 45₁ and the operational amplifier 45₂ can supply the grayscale voltages V_{g1} to V_{gi} including the middle grayscale from the nodes N₁ to Ni. Also, all of the nodes N₁ to Nₙ are connected to the nodes N₁ to Nₙ to which the other LCD source driver ICs 10B correspond. Moreover, as mentioned above, the resistance Rₐ is provided between the operational amplifier 45 and the node N connected to the operational amplifier 45.

(Operation of Lcd Source Driver 100B)

The operation of the LCD source driver 100B in the second embodiment is basically same as the first embodiment. Thus, the detailed description thereof is omitted. In the second embodiment, similarly to the first embodiment, the output ends of the operational amplifiers 45 of the different LCD source driver ICs 10B are connected through the resistance Rₐ to each other. Thus, it is possible to prevent the abnormal current from being generated between the operational amplifiers 45-1 to 45-2. Thus, even in the configuration that has the m operational amplifiers 45 for determining the grayscale signal V_{g} of the middle grayscale level, the outputs of the operational amplifiers 45 between the plurality of LCD source driver ICs 10B can be connected to each other. Moreover, the grayscale characteristic can be freely determined in the LCD source driver 100B based on the reference voltages V₁ to Vₘ that can be externally set. Also, as described in the first embodiment, the offset voltages of the respective grayscale power supply operational amplifiers 45 in the first and second LCD source driver ICs 10B-1, 10B-2 are averaged, thereby determining the displaying grayscale at the common grayscale voltage. Therefore, even if the LCD source driver IC 10B drives the data line X in response to the grayscale voltage based on the same reference supply power supply, the block unevenness is never generated on the LCD panel 300.

### Third Embodiment

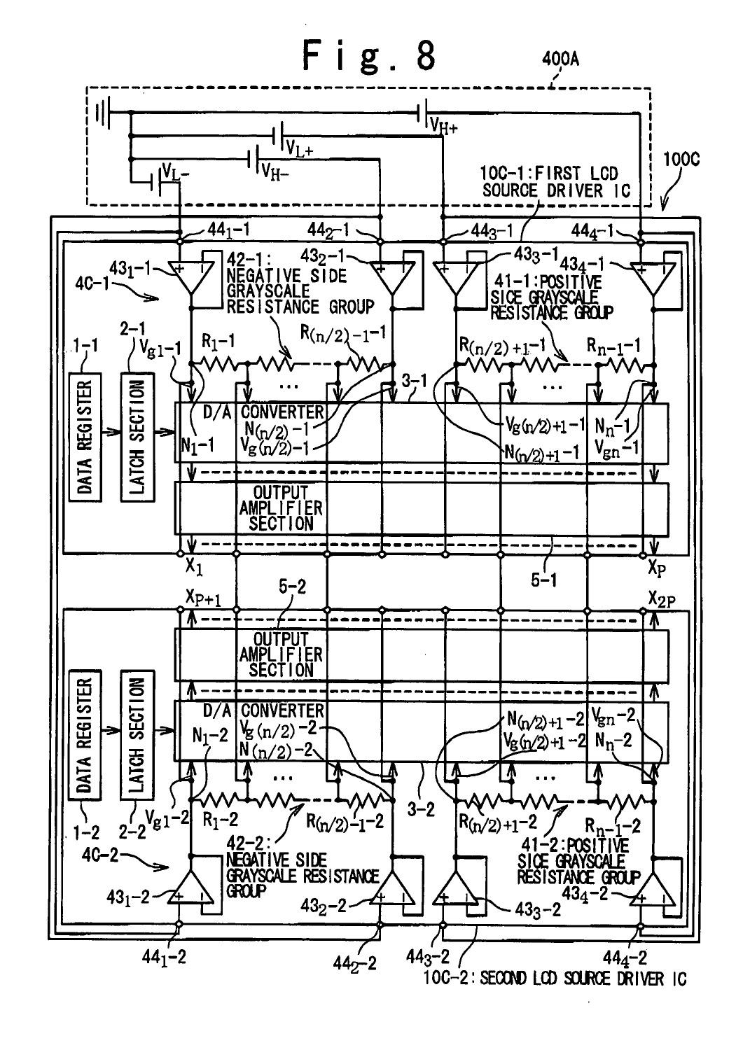

The liquid crystal display according to the third embodiment of the present invention will be described below with reference to FIG. 8. The liquid crystal display in the third embodiment is configured such that the LCD source driver 100A in the first embodiment is replaced with the LCD source driver 100C.

FIG. 8 is a block diagram showing the configuration of the LCD source driver 100C in the third embodiment. With reference to FIG. 8, the LCD source driver 100C has a first LCD source driver IC 10C-1 and a second LCD source driver IC 10C-2. The LCD source driver IC 10C has a grayscale voltage generating circuit 4C, the data resistance 1, the latch circuit 2, the D/A converter 3 and the output amplifier section 5.

The grayscale voltage generating circuit 4C is configured such that the resistances Rₐ₁ to Rₐ₄ in the grayscale voltage generating circuit 4A in the first embodiment are set to 0Ω and only the connections between the node N₁-1 and the node N₁-2, between the node N_{(n/2)}-1 and the node N_{(n/2)}-2, between the node N_{(n/2)+1}-1 and the node N_{(n/2)+1}-2 and between the node Nₙ-1 and the node Nₙ-2 are opened. The third embodiment is effective in case that the resistances cannot be provided at the output end of the operational amplifier 43. In this case, in order to prevent the abnormal current from flowing due to the shorted state between the outputs of the operational amplifiers 43, the connection between the nodes N in which in the first embodiment, the operational amplifiers 43 are connected to the output ends of the operational amplifiers 43 of the other LCD source drivers without any intervention of the resistance are opened, and the other nodes are commonly connected.

(Operation of LCD Source Driver 100C)

The operation of the LCD source driver 100C in the third embodiment is basically the same as that of the first embodiment. Thus, the detailed description will be omitted. In the third embodiment, the LCD source driver IC 10C-1 and the LCD source driver IC 10C-2 are opened between the nodes N that supply the highest voltage Vg_{(n/2}) or V_{gn} and the lowest voltage V_{g1} or Vg_{(n/2)+1} in the grayscale voltage V_{g}. The highest voltage V_{g(n/2)} or V_{gn} and the lowest voltage V_{g1} or V_{g(n/2)+1} in the grayscale voltage are the grayscale voltages to drive the data lines X close the white and black displaying, with regard to the operation of the LCD module. This grayscale is low in sensibility, and a slight voltage error between the LCD source drivers 10C is not recognized as a grayscale error. Thus, this is hard to recognize as the block unevenness.

As mentioned above, according to the LCD source driver 100 based on the present invention, even if the grayscale power supply operational amplifiers built in the plurality of LCD source driver ICs 10 have the different offset voltages, the display block unevenness is never generated in the LCD panel 300. Also, the effect of improving the phase margin for the capacitive load in the operational amplifier 43 can be expected.

Although the embodiments of the present invention have been detailed as mentioned above, the specific configuration is not limited to the above-mentioned embodiments. Even the change belonging to the range without departing from the scope and spirit of the present invention is included in the present invention.

What is claimed is:

1. A liquid crystal display (LCD) driver integrated circuit comprises:
a grayscale voltage generating circuit configured to generate a plurality of grayscale voltages from a set of supply reference voltages; and
a converting section having connection terminals and configured to drive each of a plurality of data lines of a liquid-crystal display panel through one of said connection terminals based on one of said plurality of grayscale voltages which is determined based on an input data, when each of a plurality of scanning lines of the liquid crystal display panel is driven,
said grayscale voltage generating circuit comprises:
a resistance circuit having resistances connected in series; and
a plurality of voltage buffers connected to said resistance circuit to bias said resistance circuit,
when two of said LCD driver integrated circuits are used, non-inversion input terminals of pairs of one of said plurality of voltage buffers in one of said two LCD driver integrated circuits and corresponding one of said plurality of voltage buffers in the other of said two LCD driver integrated circuits are connected in common to said reference voltage generating circuit, and
a part of said connection terminals in one of said two LCD driver integrated circuits and a corresponding part of said connection terminals in the other of said two LCD driver integrated circuits are connected to each other.

2. The LCD driver integrated circuit according to claim 1, wherein said plurality of voltage buffers comprises two voltage buffers connected to ends of said resistance circuit.

3. The LCD driver integrated circuit according to claim 2, wherein said grayscale voltage generating circuit further comprises:
a protection resistance connected between said resistance circuit and an output of each of said two voltage buffers.

4. The LCD driver integrated circuit according to claim 3, wherein all of said connection terminals in one of said two LCD driver integrated circuits and all of said connection terminals in the other of said two LCD driver integrated circuits are connected to each other.

5. The LCD apparatus according to claim 2, wherein all of said connection terminals other than said connection terminal corresponding to said ends in one of said two LCD driver integrated circuits and all of said connection terminals other than said connection terminal corresponding to said ends in the other of said two LCD driver integrated circuits are connected to each other.

6. The LCD apparatus according to claim 1, wherein said grayscale voltage generating circuit comprises said plurality of voltage buffers connected to nodes between said resistances of said resistance circuit to bias said resistance circuit, and
said reference voltage generating circuit generates the set of supply reference voltages for said plurality of voltage buffers.

7. An liquid crystal display (LCD) apparatus comprising:
an LCD panel having a plurality of data lines and a plurality of scanning lines, wherein pixels are provided at intersections of said plurality of data lines and said plurality of scanning lines;
a reference voltage generating circuit configured to generate a set of supply reference voltages; and
two driver integrated circuits connected to each other through said plurality of data lines,
wherein each of said plurality of driver integrated circuits comprises:
a grayscale voltage generating circuit configured to generate a plurality of grayscale voltages from the set of supply reference voltages; and
a converting section having connection terminals and configured to drive each of said plurality of data lines through one of said connection terminals based on one of said plurality of grayscale voltages which is determined based on an input data, when each of said plurality of scanning lines is driven,
said grayscale voltage generating circuit comprises:
a resistance circuit having resistances connected in series; and
a plurality of voltage buffers connected to said resistance circuit to bias said resistance circuit,
non-inversion input terminals of pairs of one of said plurality of voltage buffers in one of said two driver integrated circuits and corresponding one of said plurality of voltage buffers in the other of said two driver integrated circuits are connected in common to said reference voltage generating circuit, and
at least a part of said connection terminals in one of said two driver integrated circuits and a corresponding part of said connection terminals in the other of said two driver integrated circuits are connected to each other.

8. The LCD apparatus according to claim 7, wherein said plurality of voltage buffers comprises two voltage buffers connected to ends of said resistance circuit.

9. The LCD apparatus according to claim 8, wherein said grayscale voltage generating circuit further comprises:
a protection resistance connected between said resistance circuit and an output of each of said two voltage buffers.

10. The LCD apparatus according to claim 9, wherein all of said connection terminals in one of said two driver integrated circuits and all of said connection terminals in the other of said two driver integrated circuits are connected to each other.

11. The LCD apparatus according to claim 8, wherein all of said connection terminals other than said connection terminal corresponding to said ends in one of said two driver integrated circuits and all of said connection terminals other than said connection terminal corresponding to said ends in the other of said two driver integrated circuits are connected to each other.

12. The LCD apparatus according to claim 7, wherein said grayscale voltage generating circuit comprises said plurality of voltage buffers connected to nodes between said resistances of said resistance circuit to bias said resistance circuit, and
said reference voltage generating circuit generates the set of supply reference voltages for said plurality of voltage buffers.

13. A method of displaying data in a liquid crystal display (LCD) apparatus which comprises an LCD panel having a plurality of data lines and a plurality of scanning lines, wherein pixels are provided at intersections of said plurality of data lines and said plurality of scanning lines, said method comprising:
generating a set of supply reference voltages;
generating a plurality of grayscale voltages from the set of supply reference voltages;
driving each of said plurality of data lines through one of connection terminals of a first LCD driver integrated circuit based on one of said plurality of grayscale voltages which is determined based on an input data, when each of said plurality of scanning lines is driven; and
connecting a part of said connection terminals in said first LCD driver integrated circuit and a corresponding part of said connection terminals in a second LCD driver integrated circuit to each other.

14. The method according to claim 13, wherein non-inversion input terminals of pairs of one of a plurality of voltage buffers in said first LCD driver integrated circuit and corresponding one of said plurality of voltage buffers in said second LCD driver integrated circuit are connected in common to the set of supply reference voltages.

15. The method according to claim 14, wherein said generating a plurality of grayscale voltages comprises:
connecting a protection resistance between said resistance circuit and an output of each of two voltage buffers as said plurality of voltage buffers, and
said driving comprises:
connecting all of said connection terminals in one of said two driver integrated circuits and all of said connection terminals in the other of said two driver integrated circuits to each other.

16. The method according to claim 14, wherein all of said connection terminals other than said connection terminal corresponding to said ends in one of said two driver integrated circuits and all of said connection terminals other than said connection terminal corresponding to said ends in the other of said two driver integrated circuits are connected to each other.
